(19) United States
(12) Patent Application Publication
(10) Pub. No.: US 2008/0154914 A1
(43) Pub. Date: Jun. 26, 2008

(54) STORAGE SYSTEM, DATA PROTECTION METHOD, AND PROGRAM

(75) Inventors: Masaki Kan, Tokyo (JP); Yoshihiro Hasebe, Tokyo (JP); Shugo Ogawa, Tokyo (JP)

Correspondence Address: KATTEN MUCHIN ROSENMAN LLP, 575 MADISON AVENUE, NEW YORK, NY, 10022-2585, US

(73) Assignee: NEC Corporation, Tokyo (JP)

(21) Appl. No.: 11/752,050

(22) Filed: May 22, 2007

(30) Foreign Application Priority Data
May 26, 2006 (JP) 2006-147095

(51) Int. Cl. G11B 15/68

(52) U.S. Cl. 707/10

(57) ABSTRACT

Disclosed is a system including a storage that includes a high-speed response past data protection unit that holds high-speed response past data, a continuous data protection unit that performs continuous data protection, a data synthesis unit that synthesizes data using the data in the high-speed response past data protection unit and data in the continuous data protection unit, and a past data updating unit that creates data corresponding to a predetermined trigger in advance. The past data updating unit restores the data corresponding to the predetermined trigger in advance. The data synthesis unit returns the high-speed response past data stored and held in the high-speed response past data protection unit. For a request to access data other than the one at the predetermined trigger, the data synthesis unit returns the data synthesized.

This application is based upon and claims the benefit of priority from Japanese patent application No. 2006-147095, filed on May 26, 2006, the disclosure of which is incorporated herein in its entirety by reference.

### FIELD OF THE INVENTION

The present invention relates to a storage system. More specifically, the invention relates to a storage system that performs data protection, a data protection method, and a program.

### BACKGROUND OF THE INVENTION

In a storage system of which availability and fault tolerance are required, consistency of restored data and reduction of a recovery time are demanded at a time of a system failure. That is, at a time of the failure, recovery (restoration) of data up to the moment the failure occurred is performed. A data protection approach with both of a recovery time (RTO) and a recovery point objective (RPO) thereof being short is demanded. The recovery point objective (RPO) is an indicator showing how close to a point immediately preceding the failure the data can be restored back.

A backup approach periodically backs up overall data or an update portion of the data onto a disk or data unit. However, when the failure occurs in the afternoon in an operation mode where backup is performed once in a day at 0 o'clock, for example, the backup must be performed back to the backup point of 0 o'clock, which is 12 hours or more before the failure.

On the other hand, a snapshot records pointer information indicating a position of data in a disk. The snapshot does not record actual data, and a time required for the recording is also short. For this reason, by narrowing an interval of execution of the snapshot, the RPO can be reduced. However, accessing back data on a second-to-second basis is difficult, operationally.

As typical examples of the data protection approach that allows access to past data as described above, there are provided following approaches:

(a) recording updated information on a file or a block in a log (difference management mechanism) when the file or the block is updated; and

(b) recording of the snapshot at a certain point of time in the past.

As the above-described approach (a), there are provided:

CDP (Continuous Data Protection; continuous data protection) control software;

database software; and

journaling file system.

CDP is the data protection approach in which every time data is updated, update content of the data is stored in time series. In the CDP, data writing onto a storage is tracked, and captured. When a data update occurs, update content of the data is journaled to a secondary storage (an alteration history database). This allows data in any point in the past to be reproduced (Any Point In time (APIT) Recovery), and a data loss can be thereby avoided. This operation corresponds to continuation of taking an additional backup on a second-to-second basis. While only data on the order of several ten minutes can be restored by the snapshot, a recovery point of data can be set at a several-second level in the CDP. Overall actual data cannot be restored just by alteration history recording of the data. Thus, replication of an entire volume of the data is performed at a starting point, and an alteration history of this replication is recorded in time series (refer to Non-patent Documents 1 and 2). As types of the CDP, a block type, a file type, and an application type are provided. In the block type, data alteration is tracked for each block at a physical disk level or a logical volume level. In the file type, data alteration is tracked at a file level. In the application type, a sequence of a specific application is recognized by log information or an API, and tracking is performed for each file update or for each event. A minimum frequency with which each block is tracked is set to be once every second or more than once every second, for example. In the file type and the application type, a minimum frequency with which the tracking is performed is set to be once for each file update or each event update, for example. With respect to writing onto the secondary storage, synchronous-type writing and asynchronous-type writing are provided. Incidentally, as the CDP software, “TimData™ ” by TimeSpring Software Corporation or the like is commercially available.

As the above-mentioned approach (b), VSS™ (Virtual Shadow copy Service) by Microsoft Corporation is provided. In the VSS™, a snapshot that can be used for backup of data is created, thereby providing service so that a requirement for consistency between a file system and application data is satisfied. Microsoft Corporation provides a DPM™ (Data Protection Manager) that uses the VSS as a technique close to the CDP.

### [Non-Patent Document 1]

Latest Data Protection Technique Capable of Performing Recovery of Data to Arbitrary Point “Continuous Data Protection”, Internet <URL: http://enterprise.watch.impress.co.jp/cda/storage/2005/03/07/4771.html

### [Non-Patent Document 2]

CDP (Continuous Data Protection)—Any Point In Time Recovery: Technique Capable of Performing Recovery to Any Point in Time in the Past—Internet <URL: http://www.tel.co.jp/cn/magazine/vol18/it_trend2.html>

### SUMMARY OF THE DISCLOSURE

In the above-mentioned approach (a), in order to access past data (data at a desired trigger), log (difference data) from a backup taken in the past or current data is used to perform restoration (restoration), as shown in FIG. 11A. In this case, in order to perform restoration using the log from the backup, log restoration processing (roll-backing or roll-forwarding) becomes necessary. For this reason, it takes time to perform processing.

In order to provide past data (data at a desired trigger) to an access request source at high speed without performing the restoration processing, it is necessary to hold complete backups (backups capable of making high-speed response) at all points in time in the past, as shown in FIG. 11B, for example. In this approach, however, a storage capacity of data may become enormous, and an enormous disk capacity therefore becomes necessary.

In order to solve this problem, data storage intervals may be increased in FIG. 11B. In this case, however, data at any timing cannot be provided to the access request source.

Referring to FIG. 11B, it originally takes about several seconds even to obtain a snapshot. A time interval of backup data (snapshots) held in time series is therefore limited by a time required for taking the snapshot. Restoration of data for each second is therefore difficult. In other words, even if the data storage interval is minimized, the restoration of data for each second is difficult.

Accordingly, implementation of a system that allows a user or a higher-level application to access data at any arbitrary point is desired.

Assume a system which returns a state of a storage at a point in time when a request by a high-class user or the like is made, as a response to the request. In such a system, when data is received from the storage at an inappropriate timing, the data may not be able to be used without alteration, depending on the application (refer to FIG. 7). In the case of FIG. 7, as a response to an access request to a storage at a certain trigger, data at a time of updating is returned as a file at the certain trigger. In this case, it is necessary for the application to restore the data to a usable state and then use the restored data. This need is generated because the point of time in the past specified by the user is not the timing which is convenient for the application. The Word™ of Microsoft Corporation, for example, includes a restoring function of performing restoration from temporarily held data when an application stops at an unexpected timing. In an example shown in FIG. 7, it is necessary for an application side to restore data received from the storage using the restoring function described above. This puts a burden on the application side.

Accordingly, a system including on a storage side thereof a function of returning data at a timing that is convenient for the application (and that is convenient for the user as well), as a response, is desired.

Accordingly, an exemplary object of the present invention is to provide a system, a method, and a computer program capable of accessing arbitrary past data and making high-speed response.

Another object of the present invention is to provide a system, a method, and a computer program capable of returning past data at a timing that is convenient for an application (and that is convenient timing for a user as well), as a response.

The above and other objects are attained by a storage system in accordance with one aspect of the present invention, including a storage that stores data and that records update content of data in time series as a log when update of the data occurs and restores data at a point in time in the past to implement data protection function; and a past data updating unit that creates data corresponding to a predetermined trigger (also termed as moment) using data and log information stored and held in said storage and stores the created data in said storage as the data corresponding to the predetermined trigger.

In the present invention, the storage system includes a storage, having a data protection function capable of restoring data at a point in time in the past by recording update content of the data in time series as a log when update of the data occurs; a trigger transmission unit for extracting a predetermined trigger for data access based on at least a result of analysis of information on a history of access to the storage and information notified from outside; and a past data updating unit for creating data corresponding to the extracted predetermined trigger using data and log information stored and held in the storage and storing the created data in the storage as the data corresponding to the predetermined trigger.

The system according to the present invention includes: a data synthesis unit for performing control so that the data created in advance and corresponding to the predetermined trigger is used as a response to an access request to the storage without performing data restoration when the access request to the storage is an access request to the data corresponding to the predetermined trigger, and restoring the data from the data and the log information stored and held in the storage and returning the restored data as a response to the access request when the data corresponding to the predetermined trigger is not stored in the storage.

In the present invention, the predetermined trigger may include a time point frequently accessed or expected to be frequently accessed, the time point being derived from the information on the history of access to the storage. Alternatively, the predetermined trigger is notified to the storage system from outside the storage system.

In the present invention, past data at respective points in time mutually spaced with a predetermined time interval interposed therebetween is stored and held, being associated with the respective points in time, in the storage,

regarding data update occurring in a time segment for which no past data is stored, update content is recorded in time series in the log as the difference information, and

the storage system includes a data synthesis unit for searching whether data at a point in time specified by the access request is stored in the storage as one of the past data and returning the past data at the specified time point as a response to the access request when the past data at the specified time point is present, and obtaining a neighboring one of the past data at a point in time in the neighborhood of the specified time point when the past data at the time point specified by the access request is not stored in the storage, obtaining the log information corresponding to a difference between the neighboring past data and the data at the specified time point, restoring the data corresponding to the specified time point from the neighboring past data and the log information, and then returning the restored data as a response to the access request.

A storage system in accordance with another aspect of the present invention includes: a storage that stores data and that records update content of data in time series as a log when update of the data occurs and is capable of restoring data at a point in time in the past to implement data protection function;

a quiescent point management unit that detects a quiescent point of data; and

a data synthesis unit that performs control so as to return the data corresponding to the quiescent point as a response to an access request to said storage.

A storage system according to further aspect of the present invention comprises:

a storage including:

a response past data hold unit for holding response past data;

a continuous data protection unit for performing continuous data protection; and

a data synthesis unit for synthesizing data using the data in the response past data hold unit and data in the continuous data protection unit; and

a past data updating unit for creating data corresponding to a predetermined trigger in advance;

the past data updating unit restoring the data corresponding to the predetermined trigger in advance with reference to the response past data in the response past data hold unit and the data in the continuous data protection unit, and storing the restored data in the response past data hold unit;

the data synthesis unit returning the data corresponding to the predetermined trigger, stored and held in the response past data hold unit, as a response to an access request to the data at the predetermined trigger, and returning the data synthesized using the data in the response past data hold unit and the data in the continuous data protection unit as a response to an access request to data other than the data at the predetermined trigger.

The system according to the present invention, includes:

trigger transmission unit for transmitting the trigger to the past data updating unit based on a result of analysis of information on a history of access to the storage or information notified from outside.

In the present invention, the continuous data protection unit may monitor data write access to the storage, and when a data update occurs, the continuous data protection unit may journal a difference resulting from the data update to the storage as a log.

In the present invention, the trigger transmission unit notifies to the past data updating unit a time at which one of the past data should be held,

the past data updating unit extracts from the past data a neighboring one of the response past data at a time in the neighborhood of the specified time, and obtains difference information between the neighboring data at the time in the neighborhood of the specified time and the data at the specified time, and

the data corresponding to the specified time is synthesized using the data and the difference information, and the synthesized data is stored in the response past data hold unit.

In the present invention, the trigger transmission unit notifies to the past data updating unit data unnecessary as one of the past data, and the past data updating unit deletes the notified past data from the response past data.

In the present invention, the trigger transmission unit analyzes an access log, notifies to the past data updating unit a time with access concentrated thereat and access target data, and notifies to the past data updating unit deletion of one of the past data unused in the response past data hold unit.

In the present invention, it may be so arranged that upon receipt of a read request specifying a time, the data synthesis unit searches whether one of the response past data at the specified time is present in the responding data protection unit. Then, it may be so arranged that when the data at the specified time is present, the data synthesis unit extracts from the responding data protection unit the responding data at the specified time, and when the data at the specified time is not present, the data synthesis unit extracts a neighboring one of the response past data at a time in the neighborhood of the specified time from the responding data protection unit, obtains difference information between the extracted neighboring data and the data at the specified time from the continuous data protection unit, and synthesizes the data at the specified time using the neighboring data and the difference information.

A system in accordance with another aspect of the present invention includes: a response past data hold unit for holding response past data;

a continuous data protection unit for performing continuous data protection;

a data synthesis unit for synthesizing data from the data in the response past data hold unit and data in the continuous data protection unit; and

a quiescent point management unit for detecting a quiescent point of an application and managing the quiescent point.

Upon receipt of a request specifying a time to read required data from a storage, the quiescent point management unit obtains information on the quiescent point closest to the requested time for the target data, and notifies the information on the quiescent point to the data synthesis unit in the storage. The data synthesis unit searches whether one of the response past data at a time corresponding to the quiescent point obtained by the quiescent point management unit is present in the response past data hold unit, and extracts the data at the time corresponding to the quiescent point from the response past data hold unit when the data at the time corresponding to the quiescent point is present.

On the other hand, when the data at the time corresponding to the quiescent point is not present, the data synthesis unit extracts from the response past data hold unit a neighboring one of the response past data at a time in the neighborhood of the time corresponding to the quiescent point, obtains difference information between the extracted neighboring data and the data at the specified time, synthesizes the data at the specified time using the neighboring data and the difference information, and returns the synthesized data as a response.

A method according to another aspect of the present invention is a data protection method for a storage system comprising a storage, including a data protection function capable of restoring data at a point in time in the past by recording update content of the data in time series as a log when update of the data occurs. The method includes:

creating data corresponding to a predetermined trigger using data and log information stored and held in the storage and storing the created data in the storage as the data corresponding to the predetermined trigger.

A method according to another aspect of the present invention is a data protection method for a storage system comprising a storage, including a data protection function capable of restoring data at a point in time in the past by recording update content of the data in time series as a log when update of the data occurs. The method includes:

extracting a predetermined trigger for data access based on at least a result of analysis of information on a history of access to the storage and information notified from outside; and

creating data corresponding to the extracted predetermined trigger using data and log information stored and held in the storage and storing the created data in the storage as the data corresponding to the predetermined trigger.

The method according to the present invention includes:

performing control so that the data created in advance and corresponding to the predetermined trigger is used as a response to an access request to the storage without performing data restoration when the access request to the storage is an access request to the data corresponding to the predetermined trigger, and

restoring the data from data and the log information stored and held in the storage and returning the restored data as a response to the access request when the data corresponding to the predetermined trigger is not stored in the storage.

In the method according to the present invention, the predetermined trigger includes a time point frequently accessed or expected to be frequently accessed, the time point being derived from the information on the history of access to the storage. Alternatively, the predetermined trigger is notified to the storage system from outside the storage system.

In the method according to the present invention, past data at respective points in time mutually spaced with a predetermined time interval interposed therebetween is stored and held, being associated with the respective points in time, in the storage,

regarding data update occurring in a time segment for which no past data is stored, update content is recorded in time series in the log as the difference information,

it is searched whether data at a point in time specified by the access request is stored in the storage as one of the past data and the past data at the specified time point is returned as a response to the access request when the past data at the specified time point is present, and

when the past data at the time point specified by the access request is not present, a neighboring one of the past data at a point in time in the neighborhood of the specified time point and the log information corresponding to a difference between the neighboring past data and the data at the specified time point are obtained. Then, the data corresponding to the specified time point is restored from the neighboring past data and the log information, and the restored data is returned as a response to the access request.

A method according to another aspect of the present invention is a data protection method for a storage system including a storage, having a data protection function capable of restoring data at a point in time in the past by recording update content of the data in time series as a log when update of the data occurs. The method includes steps of:

detecting a quiescent point of the data; and

performing control so that the data corresponding to the quiescent point is returned as a response to an access request to the storage.

A computer program according to the present invention is a program for a computer constituting a storage system including a storage. The storage system is equipped with a data protection function capable of restoring data at a point in time in the past by executing processing of recording update content of the data in time series as a log when update of the data occurs. The program causes the computer to execute processing of:

creating data corresponding to a predetermined trigger using data and log information stored and held in the storage; and

storing the created data in the storage as the data corresponding to the predetermined trigger.

A computer program according to the present invention is a program for a computer constituting a storage system including a storage. The storage system has a data protection function capable of restoring data at a point in time in the past by executing processing of recording update content of the data in time series as a log when update of the data occurs. The program causes the computer to execute processing of:

extracting a predetermined trigger for data access based on at least a result of analysis of information on a history of access to the storage and information notified from outside; and

creating data corresponding to the extracted predetermined trigger using data and log information stored and held in the storage and storing the created data in the storage as the data corresponding to the predetermined trigger.

A program of the present invention is the program for a computer constituting a storage system. The storage system includes: a response past data hold unit for holding response past data; and a continuous data protection unit for performing continuous data protection.

The storage system executes:

past data updating processing of creating data corresponding to a predetermined trigger in advance; and

data synthesis processing of synthesizing data using the data in the response past data hold unit and data in the continuous data protection unit. The program causes the computer to execute:

the past data updating processing of restoring the data corresponding to the predetermined trigger in advance with reference to the past data in the response past data hold unit and the data in the continuous data protection unit, and storing the restored data in the response past data hold unit; and

the data synthesis processing of returning one of the data stored and held in the response past data hold unit as a response to an access request to the data at the predetermined trigger, and returning the data synthesized using the data in the response past data hold unit and the data in the continuous data protection unit as a response to an access request to data other than the data at the predetermined trigger.

The program according to the present invention causes the computer to execute trigger transmission processing of transmitting the trigger to the past data updating unit based on a result of analysis of an access log or information notified from outside.

In the program according to the present invention, a time at which one of the past data should be held is notified to the past data updating processing in the trigger transmission processing, and in the past data updating processing, a neighboring one of the past data at a time in the neighborhood of the specified time is extracted from the past data and difference information between the neighboring data at the time in the neighborhood of the specified time and the data at the specified time is obtained from the continuous data protection unit, and the data corresponding to the specified time is synthesized using the neighboring data and the difference information, and the synthesized data is stored in the response past data hold unit.

In the program according to the present invention, data unnecessary as one of the past data is notified to the past data updating unit in the trigger transmission processing, and the past data updating unit deletes the notified past data from the response past data.

In the program according to the present invention, the access log is analyzed, and a time with access concentrated thereat and access target data are notified to the past data updating processing, and deletion of one of the past data unused in the response past data hold unit is notified to the past data updating unit, in the trigger transmission processing.

In the program according to the present invention, in the data synthesis processing, upon receipt of a read request specifying a time, it is searched whether one of the response past data at the specified time is present in the responding data protection unit. When the data at the specified time is present, the responding data at the specified time is extracted from the responding data protection unit, in the data synthesis processing. On the other hand, when the data at the specified time is not present, the data synthesis processing extracts a neighboring one of the response past data at a time in the neighborhood of the specified time from the responding data protection unit, obtains difference information between the extracted neighboring data and the data at the specified time from the continuous data protection unit, and synthesizes the data at the specified time using the neighboring data and the difference information.

A program of the present invention is the program for a computer constituting a storage system. The storage system includes:

a response past data hold unit for holding response past data; and

a continuous data protection unit for performing continuous data protection.

The storage system executes:

data synthesis processing of synthesizing data using the data in the response past data hold unit and data in the continuous data protection unit; and

quiescent point management processing of detecting a quiescent point of an application and managing the quiescent point.

The program causes the computer to execute:

the quiescent point management processing of obtaining information on the quiescent point closest to a requested time for target data, and notifying the information on the quiescent point to the data synthesis processing in the storage, upon receipt of a read request specifying the time to read the required data from the storage; and the data synthesis processing of searching whether one of the response past data at a time corresponding to the quiescent point is present in the response past data hold unit,

extracting from the response past data hold unit the data at the specified time corresponding to the quiescent point when the data at the specified time corresponding to the quiescent point is present; and

extracting from the response past data hold unit a neighboring one of the response past data at a time in the neighborhood of the specified time corresponding to the quiescent point when the data at the specified time corresponding to the quiescent point is not present, obtaining difference information between the extracted neighboring data and the data at the specified time, synthesizing the data at the specified time using the neighboring data and the difference information, and returning the synthesized data as a response.

The meritorious effects of the present invention are summarized as follows.

According to the present invention, past data at a point in time to which an access request is expected to be made is created in advance, and synthesis and restoration processing using difference data is not therefore needed for the past data. Access to the past data can be thereby sped up.

Further, according to the present invention, the storage system returns data at a quiescent point as a response. Data restoration processing on an application side thereby becomes unnecessary. Access to past data can be thereby sped up.

Still other features and advantages of the present invention will become readily apparent to those skilled in this art from the following detailed description in conjunction with the accompanying drawings wherein examples of the invention are shown and described, simply by way of illustration of the mode contemplated of carrying out this invention. As will be realized, the invention is capable of other and different examples, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIGS. 1A and 1B include diagrams for explaining the operation principle underlying an example of the present invention;

FIG. 2 is a diagram showing a configuration of a first example of the present invention;

FIG. 3A is a flowchart for explaining an operation of the first example of the present invention;

FIG. 3B is a flowchart for explaining an operation of the first example of the present invention;

FIG. 4A is a flowchart for explaining an operation of the first example of the present invention;

FIG. 4B is a flowchart for explaining an operation of the first example of the present invention;

FIG. 5 is a flowchart for explaining a READ operation in the first example of the present invention;

FIG. 6 is a graph for explaining detection of a trigger based on an access log in the first example of the present invention;

FIG. 7 is a diagram illustrating an operation of obtaining a file at a trigger (at a time of a data update) other than a quiescent point;

FIG. 8 is a diagram illustrating an operation of obtaining a file at a trigger of a quiescent point in response to an access in another example of the present invention;

FIG. 9 is a diagram showing a configuration of a second example of the present invention;

FIG. 10 is a flowchart for explaining a READ operation in the second example of the present invention;

FIG. 11A is a diagram for explaining a CDP approach; and

FIG. 11B is a diagram for explaining a snapshot.

### EXAMPLES OF THE INVENTION

Examples according to the present invention will be described below with reference to appended drawings. In one mode of the present invention, past data at a point in time frequently accessed or to be frequently accessed, or past data corresponding to a trigger or moment specified from outside is created in advance, and together with other high-speed response past data, the past data is associated with the trigger and stored in a storage in time series, for example. Then, for updating of data in a period between these past data, difference information is held as a log.

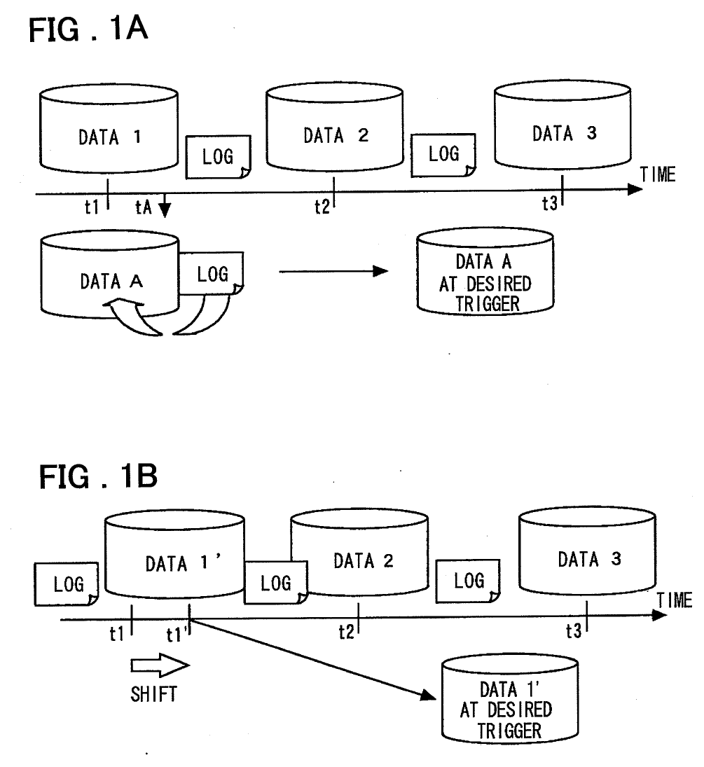

That is, as a basic configuration of one aspect of the present invention, data is periodically backed up and for the period between backups, the difference information (log) is held in time series. FIG. 1 is a schematic diagram showing information held in the storage in time series. As shown in FIG. 1A, storage data at respective points in time t1, t2, t3, and the like is backed up as data 1, data 2, data 3, and so on, respectively. Data alteration in a period between the points in time t1 and t2 when data is backed up and data alteration in a period between the points in time t2 and t3 when data is backed up are held as the logs (difference information), respectively. FIG. 1A shows a configuration in which one log is stored (or one data update is performed) in each of the period between the points in time t1 and t2 and the period between the points in time t2 and t3, just for simplification. A configuration in which a plurality of logs are held in time series in each period may be of course used. In addition to a data alteration point (difference information), journaling that records a generated transaction may be of course employed as the log.

With the configuration as described above, response can be comparatively sped up. A storage capacity can also be comparatively kept to be small.

With respect to data (such as data at a point in time tA) between data at a trigger or moment desired by a user, restored data A obtained by synthesis of the data 1 and the log corresponding to the data 1 is returned as a response. The above description corresponds to a continuous data protecting function.

One of main features of the present invention is that when access frequency at a certain point of time is found to be high, for example, data (data 1′ in FIG. 1B) corresponding to a trigger (a time point t1′) with the high access frequency is created in advance instead of regularly-created data, based on an access log that holds a history of past access to the storage, and the created data is stored and held, being associated with the trigger. That is, the created data 1′ is stored and held in time series, together with the data 2 and 3 created by regular backup at the points in time t2 and t3, respectively. More specifically, the data 1′ created corresponding to the time point t1′ using the data at the time point t1 and the log is associated with time information indicating that the data 1′ is the data between the points of time t1 and t2, and stored and held.

For alteration of data in a period between the data 1′ at the time point t1′ having the high access frequency and the data 2 at the next time point t2, a difference (log) is held. Though no particular limitation is imposed, the data 1 created by the regular backup at the time point t1 (refer to FIG. 1A) is deleted after the data 1′ has been created, in FIG. 1B.

The data 1 created by the regular backup at the time point t1 (refer to FIG. 1A) may be deleted when the data 1′ at the point of time t1′ has been created, or deleted based on a result of access frequency analysis. Alternatively, when there is allowance in a storage capacity, the data 1 created by the regular backup at the point of time t1 in FIG. 1B may be of course left undeleted.

In the present invention, the storage returns the data 1′ as a response to an access request to the data 1′ at the point of time t1′ with the high access frequency. When access is made to the data 2 at the point of time t2 or the data 3 at the point of time t3, the data 2 or 3 backed up regularly may be returned as a response.

In the present invention, data between the data 1′ and the data 2 is synthesized based on the held data 1′ and the log, and returned as a response. In this case, restoration processing of the data and the log is added. Thus, a response time becomes slower than in a case where the data 1′ alone is returned. However, since access frequency of data between the data 1′ and the data 2 and access frequency of data between the data 2 and the data 3 are lower than the access frequency of the data 1′, an influence on reduction of an overall throughput is suppressed. In other words, by reducing the response time of the data 1′ frequently accessed, the overall throughput is improved.

As another mode of the present invention, control is performed so that data at a quiescent point of an application is returned as a response to a request from the user.

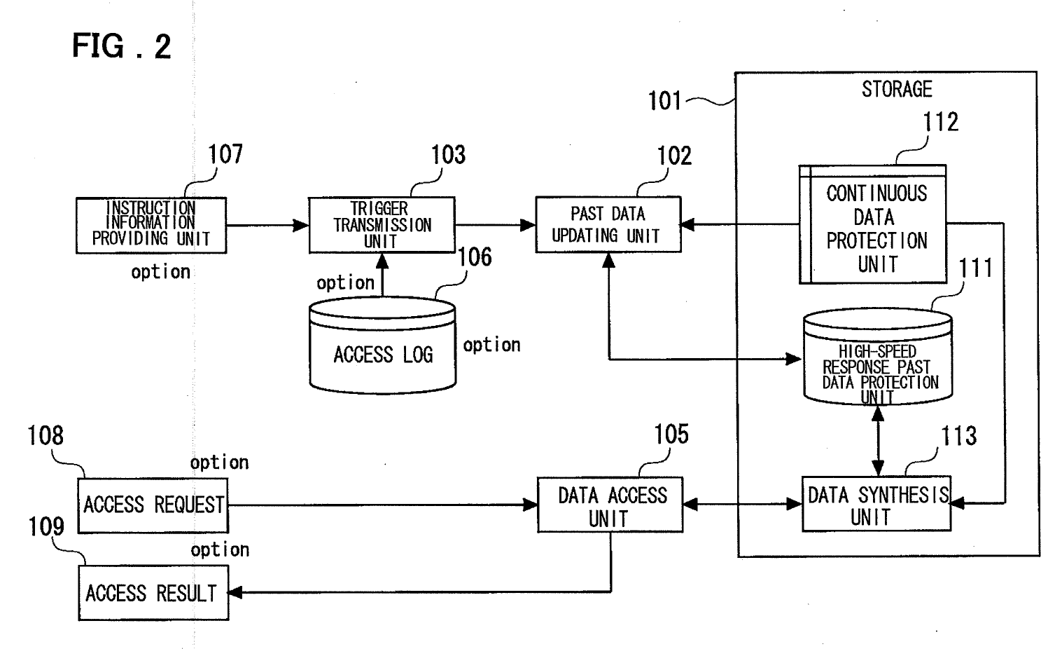

FIG. 2 is a diagram showing a configuration of a first example of the present invention. Referring to FIG. 2, a storage 101 in this example includes a high-speed response past data protection unit 111, a continuous data protection unit 112, and a data synthesis unit 113. The high-speed response past data protection unit 111 includes a storage portion that holds past data on a single or a plurality of files and objects as backups (snapshots), each capable of being returned at high speed as a response. The continuous data protection unit 112 performs continuous data protection (CDP). Using the high-speed response past data protection unit 111 and the continuous data protection unit 112, the data synthesis unit 113 synthesizes data. Preferably, the snapshots are stored in the high-speed response past data protection unit 111 in view of reduction of a disk capacity and reduction of time required for performing backup.

The continuous data protection unit 112 tracks or monitors data write access to the storage 101. When an update of data occurs, the continuous data protection unit journals update content of the data to another storage (not shown), and includes a log or a difference management mechanism.

The data synthesis unit 113 synthesizes and creates data corresponding to a trigger or moment requested, based on the data held in the high-speed response past data protection unit 111 (past data for high-speed response) and a log held in the continuous data protection unit 112, and uses the created data as a response for an access request from a user. The data synthesis unit 113, for example, synthesizes data at a predetermined trigger using the data 1′ and the associated log or the data 2 and the associated log, in FIG. 1B.

The system according to this example further includes a past data updating unit 102 and a trigger transmission unit 103. Then, data at a point in time frequently accessed or which may be frequently accessed, or data corresponding to a trigger notified from outside, for example, is created in advance.

In order to reduce or eliminate data synthesis processing in response processing by the data synthesis unit 113, the past data updating unit 102 refers to the data (log or the like) in the continuous data protection unit 112 and restores high-speed response past data in advance, thereby updating the restored data to data at a point in time frequency accessed. The data 1′ in FIG. 1B, for example, corresponds to the high-speed response past data created by the past data updating unit 102 and then stored in the high-speed response past data protection unit 111. The data 1′ at the time point frequently accessed may be a file or a snapshot of a volume, for example.

A data access unit 105 receives an access request 108 and delivers the access request to the data synthesis unit 113. The data synthesis unit 113, which has received the access request, uses the data held in the high response past data protection unit 111 and the continuous data protection unit 112 to synthesize data at a specified timing, and returns the synthesized data to the data access unit 105.

The data access unit 105 receives the data synthesized by the data synthesis unit 113 and returns the synthesized data to the user as an access result 109. The data access unit 105 may be an input/output device that is connected to the storage 101, for communication, or a server, or a controller.

The trigger transmission unit 103 derives a time point (trigger or moment) to which an access request is expected to be actually made, upon receipt of an instruction or information from an instruction information providing unit 107 or based on an access log 106 that holds an access history for the storage 101. Then, the trigger transmission unit 103 gives the trigger for creating past data to the past data updating unit 102 based on a result of derivation. Though no particular limitation is imposed, the instruction information providing unit 107 is constituted from an E mail system or an operation flow management system. Provision of an instruction by an E mail or information from the operation flow management system is input to the trigger transmission unit 103. The instruction information providing unit 107 may only give an instruction or the like to the trigger transmission unit 103, and may be configured to be provided as a system other than a storage system.

In this example, when an access request is a read request, a time point (a specified time) at which desired data is identified is set. In the case of the read request, the specified time of the data is held in the access log 106. When the specified time of the data is not set in the access request as a command parameter, latest backup data (or synthesis of the backup data with the log) as a default may be returned as a response.

An option marked for each of the access log 106, instruction information providing unit 107, and the like in FIG. 2 indicates that these are option functions that can be freely adopted or rejected. The present invention is not limited to a configuration of the instruction information providing unit 107 using the access log 106, an instruction by an E mail, or the operation flow management system. Other system, information, or the like may be of course employed. A trigger may be of course notified to the trigger transmission unit 103 by input from a management terminal (such as a console table) of a manager of the system.

A description will be given below about an example where a time is used as the trigger for creating past data. Occurrence of an event specified in advance may be used as the trigger. Detection of occurrence of these events may be performed by the operation flow management system constituting the instruction information providing unit 107 or a job scheduler (not shown), for example, and notification of the events may be performed to the trigger transmission unit 103.

When the instruction information providing unit 107 is constituted from the operation flow management system that manages an operation processing flow about the storage 101, for example, an execution time of an operation that makes access to the storage 101 is extracted from a result of operation analysis. Then, a time or the like when access to the storage 101 is concentrated is analyzed and notified to the trigger transmission unit 103.

Alternatively, the trigger transmission unit 103 may be configured to prepare for data at a point in time when synthesis is frequently performed, based on synthesis information from the data synthesis unit 113 and based on a history (number of times) where backup data and a log are synthesized in the data synthesis unit 113. Analysis based on the synthesis information from the data synthesis unit 113 is based on an actual data synthesis result that depends on stored data. That is, though an access request history is held in the access log 106, a response history (such as a data synthesis history or the like) may be held in a journal as a transaction history.

In response to notification from the instruction information providing unit 107 outside the storage or according to a trigger detected from the access log 106, the trigger transmission unit 103 instructs the past data updating unit 102 to update past data corresponding to this trigger.

The past data updating unit 102 restores data at the trigger (time point) instructed by the trigger transmission unit 103, in advance, based on high-speed response past data (backup data or snapshot) in the high-speed response past data protection unit 111 and log information in the continuous data protection unit 112.

Preferably, the high-speed response past data created by the past data updating unit 102 is data at a point in time to which an actual access request is made. In this case, restoration processing on the data in response to the access request is unnecessary.

Then, even if the high-speed response past data is slightly different from the data at the time point to which the actual access request is made, the high-speed response past data may contribute to faster restoration processing on the data at the time point to which the actual access request is made. That is, by creating data (indicated by reference numeral t1′ in FIG. 1B) between two points in time (the points in times t1 and t2 in FIG. 1B) for periodical backed up, in advance, as the high-speed response past data, a time segment with a reduced backup interval (a time segment between the points of time t1′ and t2 in FIG. 1B) is generated. Assume that, by reducing the backup interval, restoration to data at a target time point can be performed using data and one log that are stored and held. Then, a processing time of the restoration becomes shorter than a case where restoration (by roll-backing/roll-forwarding) is performed using the data and a plurality of time-series logs. For this reason, restoration processing on data at a point of time between the high-speed response past data (such as the data 1′ in FIG. 1B) and next periodical backup data (data 2 in FIG. 1B) may be sped up.

According to this example, past data to be frequently used by the user is created in advance, and then stored and held. Thus, access to the past data can be sped up. Though no particular limitation is imposed, according to this example, a timing that may be used by the user can be extracted from information on the access history or the like. Past data corresponding to this timing can be thereby created.

According to this example, by combining the trigger transmission unit 103 with the operation flow management system, for example, data to be protected can be extracted from an operation flow.

The storage 101 in FIG. 2 may include a plurality of disks, and may have a redundant configuration of an RAID (Redundant Array of Inexpensive Disks) or the like. Alternatively, the storage 101 may be a network storage system such as a NAS (Network Attached Storage) or a SAN (Storage Area Network) that communicates with a host (a client) through a network. It is also assumed that the secondary storage in which the continuous data protection unit 112 stores an alteration history is included in the storage 101.

Processing functions of the past data updating unit 102 and the trigger transmission unit 103 in FIG. 2 may also be implemented by a computer program to be executed on a computer or a controller. Processing functions of processing in the data synthesis unit 113 and processing in the high-speed response past data protection unit 111 and the continuous data protection unit 112 may be implemented by a computer program to be executed on a computer or a controller constituting the storage 101. When the storage system is configured as a file server system, the past data updating unit 102 and the trigger transmission unit 103 are implemented by a computer program that operates on a server computer.

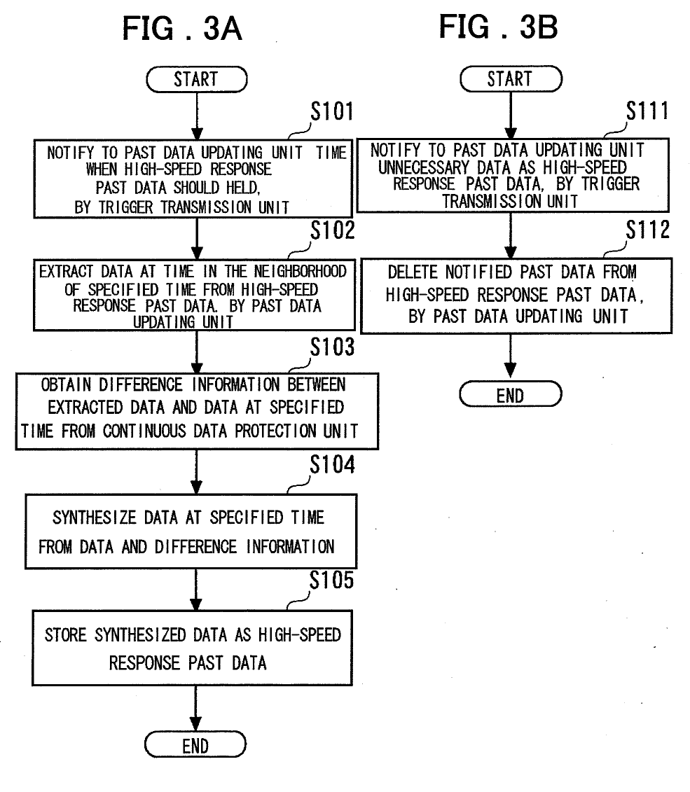

FIGS. 3A and 3B are flow diagrams showing processing procedures according to an example of the present invention, respectively. First, referring to FIG. 3A, an updating procedure of high-speed response past data in this example will be described.

The trigger transmission unit 103 notifies to the past data updating unit 102 a trigger (a time) at which the high-speed response past data should be held (at step S101). The time may include a second. As described before, the trigger transmission unit 103 detects the trigger based on a result of analysis of the access log 106 or notification from the instruction information providing unit 107.

In this example, the time is used as a trigger (trigger) for creation of the high-speed response past data. A trigger at which the past data updating unit 102 should hold the high-speed response past data, notified by the trigger transmission unit 103, may be a specific event or the like, in addition to the time. Alternatively, a combination of the time and an event (indicating after when a specific access request from the client will be generated) may be used as the trigger.

Upon receipt of notification of the trigger (time) from the trigger transmission unit 103, the past data updating unit 102 extracts neighboring data at a time in the neighborhood of the specified time, from the high-speed response past data (at step S102). The data at the time close to the specified time is data attribute information, for example. The data attribute information is retrieved and obtained, by referring to time stamp information (on an update time).

The past data updating unit 102 obtains from the continuous data protection unit 112 difference information (log) between the neighboring data in the neighborhood of the trigger (time) notified from the trigger transmission unit 103 and data at the specified time (at step S103).

The past data updating unit 102 synthesizes data corresponding to the specified time based on the neighboring data and the difference information (at step S104). When a plurality of difference information is present in time series between the time of the neighboring data and the specified time, the past data updating unit 102 synthesizes the data corresponding to the specified time, using the plurality of difference information for the neighboring data.

The past data updating unit 102 stores the synthesized data in the high-speed response past data protection unit 111 (at step S105).

Next, referring to FIG. 3B, a procedure for deleting high-speed response past data in this example will be described.

The trigger transmission unit 103 notifies to the past data updating unit 102 unnecessary data as high-speed response past data (at step S111). As a result of analysis of the access log 106, the trigger transmission unit 103 detects the unnecessary high-speed response past data of which access frequency is lower than a predetermined threshold value, or recognizes the unnecessary high-speed response past data by notification from the instruction information providing unit 107, and notifies to the past data updating unit 102 the unnecessary high-speed response past data.

The past data updating unit 102 deletes the notified past data from the high-speed response past data (at step S112).

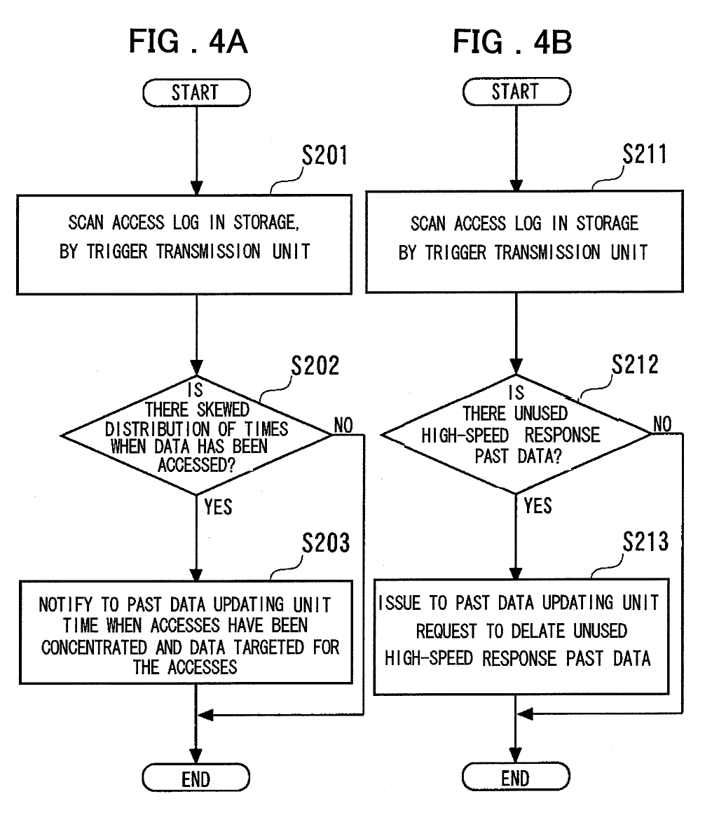

Next, referring to FIG. 4A, a procedure in which the trigger transmission unit 103 extracts a trigger from the access log 106 in this example will be described.

The trigger transmission unit 103 scans the access log 106 for the storage 101 (at step S201). A length of the access history held in the access log 106 (indicating to which point in the past access goes back to hold the history), an access frequency threshold value, and the like are set as necessary.

When there is a skewed distribution of times such a peak or the like at which data has been accessed, (branch to YES at step S202), the trigger transmission unit 103 notifies to the past data updating unit 102 a time when accesses have been concentrated, and data targeted for the accesses (at step S203).

Referring to FIG. 4B, another operation of the trigger transmission unit 103 in this example will be described.

The trigger transmission unit 103 scans the access log 106 in the storage 101 (at step S211).

When there is high-speed response past data that is not used (branch to YES at step S212), the trigger transmission unit 103 issues to the past data updating unit 102 a request to delete the high-speed response past data that is not used (at step S213). The length of the access history (to which point in the past access goes back to hold the history) held in the access log 106, the access frequency threshold value or the like by which the trigger transmission unit 103 makes determination about unused data are set as necessary.

Deletion of the high-speed response past data may also be performed by deleting unnecessary past data when the high-speed response past data is stored. By doing so, an increase in a data holding capacity is suppressed.

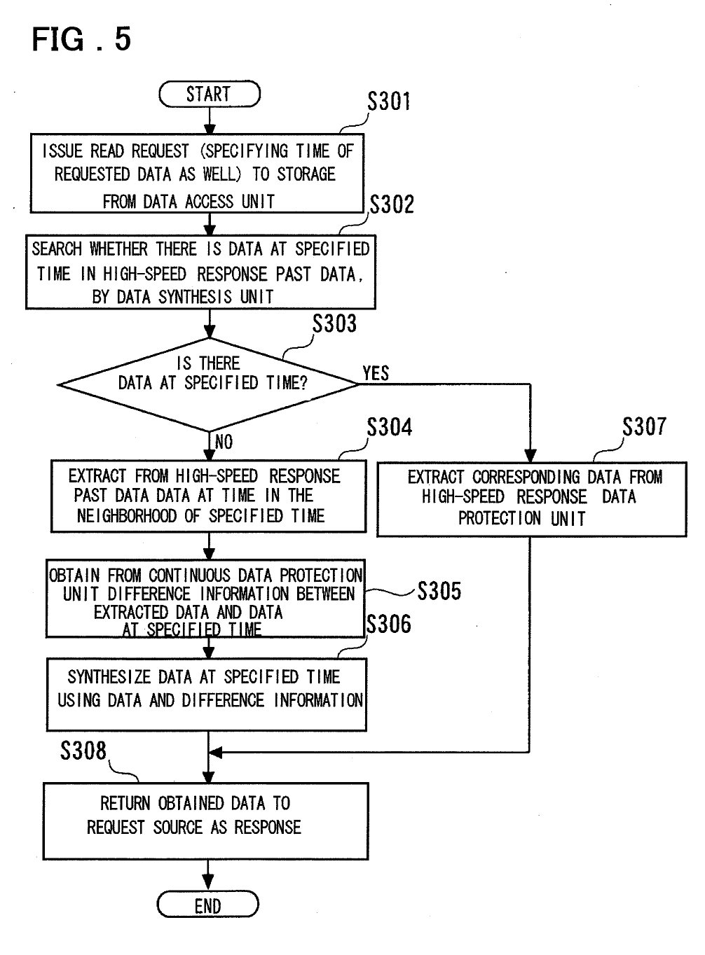

Next, a data reading operation in response to an access request (a READ request) in this example will be described with reference to FIG. 5.

The data access unit 105 that has received the access request (READ request) 108 issues to the storage 101 the READ request (that specifies a time of requested data as well, by the request) (at step S301).

The data synthesis unit 113 searches whether there is high-speed response past data at the specified time in the high-speed response past data protection unit 111 (at step S302).

When it is found as a result of the search that the data at the specified time is present in the high-speed response past data protection unit 111 (branch to YES at step S303), the data synthesis unit 113 extracts the high-speed response past data at the specified time from the high-speed response past data protection unit 111 (at step S307). The data synthesis unit 113 returns the high-speed response past data to the data access unit 105. The data access unit 105 returns the data to a request source as the access result 109 for the access request (READ request) 108 (at step S308).

When it is found as the result of the search at step S303 that there is not the data at the specified time (high-speed response past data) in the high-speed response past data protection unit 111 (branch to NO at step S303), the data synthesis unit 113 extracts from the high-speed response past data protection unit 111 neighboring data (high-speed response past data) at a time in the neighborhood of data at the specified time (at step S304).

Then, referring to the continuous data protection unit 112, the data synthesis unit 113 obtains difference information (log) between the neighboring data (high-speed respond past data) extracted from the high-speed response past data protection unit 111 and the data at the specified time (at step S305).

The data synthesis unit 113 synthesizes the data at the specified time using the neighboring data and the difference information (at step S306).

Next, an approach to detecting a trigger for creating high-speed response past data by the trigger transmission unit 103 in the present invention will be described.

In this example, according to setting of a policy using a threshold value, in which past data at a certain time (time) t is left when access to the past data at the certain time (time) t is requested the number of times corresponding to the threshold value x or more, a trigger for leaving the data in the high-speed response past data protection unit 111 may be detected.

Alternatively, the trigger for leaving the data may be calculated from statistical data on a time when the past data was accessed and access frequency of the past data. The time when the past data was accessed indicates the time t when the data at the certain time point t was requested.

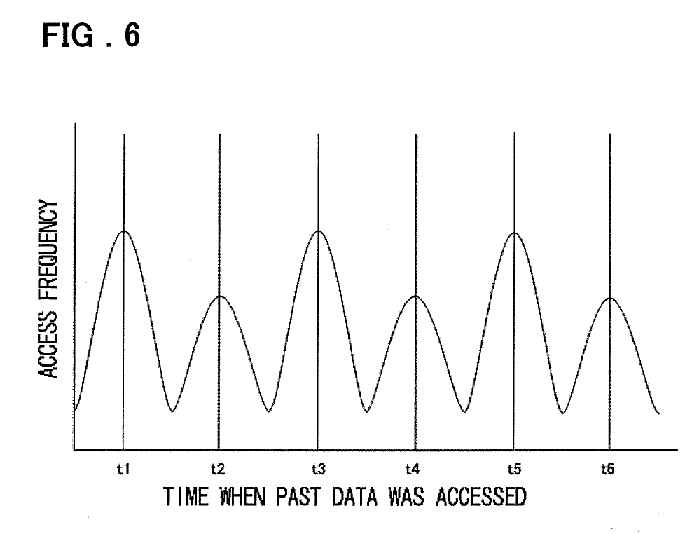

FIG. 6 is a diagram showing an example of a histogram using a time when the past data was requested and the access frequency of the past data. A horizontal axis indicates the time when the past data was accessed, while a vertical axis indicates the access frequency. Peak times are detected from a graph of the access frequency (histogram), and are used as triggers for leaving the data at the peak times. In the case of the example in FIG. 6, the data at points in time t1, t2, t3, t4, t5, and t6 are to be left. Alternatively, when a more strict storage capacity limitation is present, only data at the points in time t1, t3, and t5 may be left. FIG. 6 shows analysis in a time domain, as access frequency analysis. The analysis in a frequency domain (obtained by a Fourier Transform or the like) or the like may be performed, and access periodicity may be analyzed.

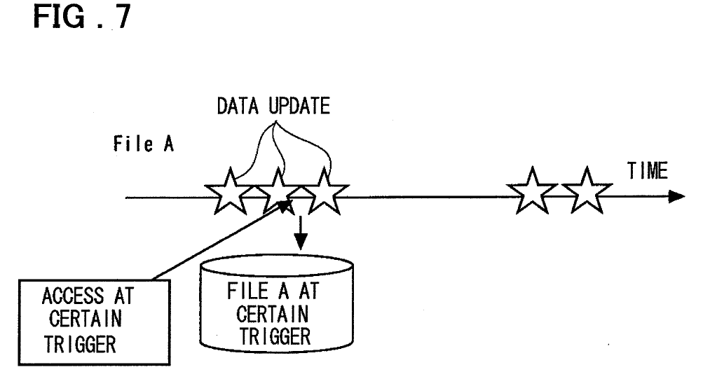

Next, another example of the present invention will be described. When data is received from the storage at an inappropriate timing with respect to the specified time point as described with reference to FIG. 7, it is necessary to restore the data to a usable state and use the restored data, on an application side.

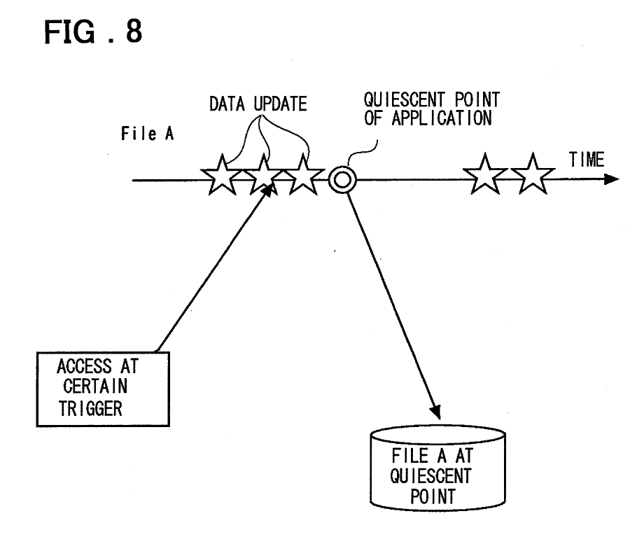

Then, in a second example of the present invention, when an access request timing is the one for a data update or the like and is not a quiescent point of the application as shown in FIG. 8, data at the quiescent point of the application is returned as a response, thereby eliminating the need for data restoration processing on the application side. Access to past data can be thereby sped up.

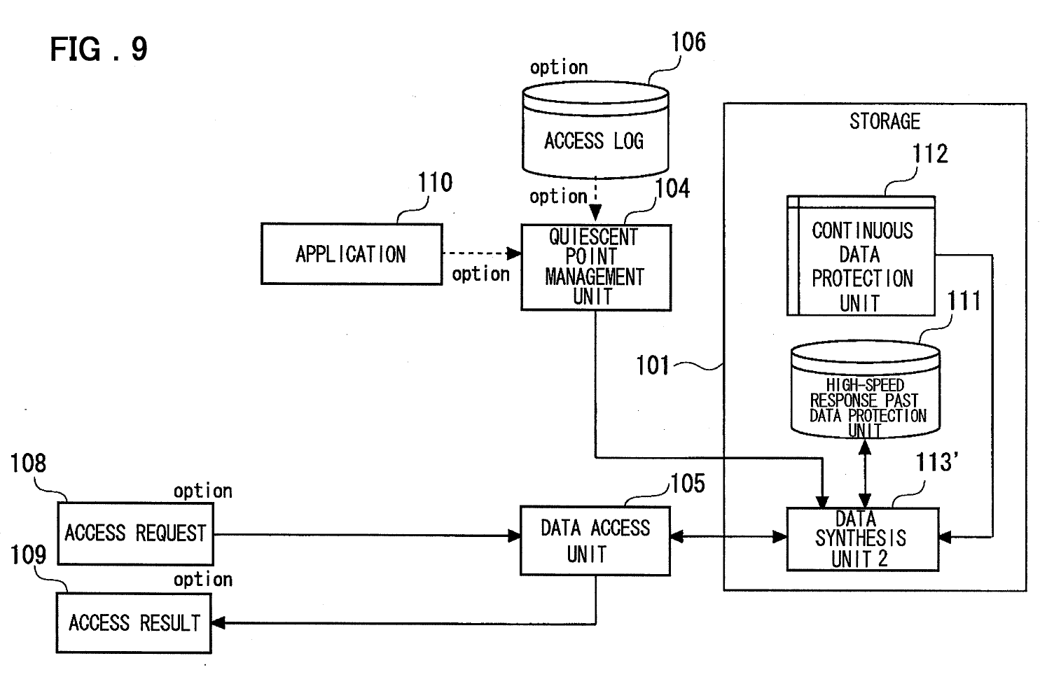

FIG. 9 is a diagram showing a configuration of a second example of the present invention. Referring to FIG. 9, the storage 101 in this example has the same structure as in the first example. The storage 101 includes a high-speed response past data protection unit 111 that includes a storage portion for holding past data in a single or a plurality of files or objects as backups (snapshots) each capable of being returned as a response at high speed, a continuous data protection unit 112 including unit (log or difference management mechanism) that implements continuous data protection, and a data synthesis unit 113′ that synthesizes data at a required trigger with reference to the data in the high-speed response past data protection unit 111 and data in the continuous data protection unit 112.

The system according to this example includes a quiescent point management unit 104 that manages a quiescent point of an application 110 and notifies the quiescent point of the application to the storage 101. The quiescent point management unit 104 detects the quiescent point of the application 110 based on notification from an API for the application 110 or the like, or the access log 106 for the storage.

As in the first example, the storage 101 has a function of restoring or extracting data at any point of time in the past from currently held data and returning the data as a response, as in the first example.

In this example, data at a trigger notified from the quiescent point management unit 104 is returned as a response for data at a trigger requested by the user.

In a method of selecting a quiescent point managed by the quiescent point management unit 104, one of data at following quiescent points is selected:
the data at the quiescent point that is closest to a trigger requested by the user (irrespective of whether the quiescent point is in the past, present, or future), and
the data at the quiescent point in the past closest to the trigger requested by the user

According to the present invention, the storage returns the data at the trigger notified by the quiescent point management unit 104 as the response. Past data can be thereby used at high speed.

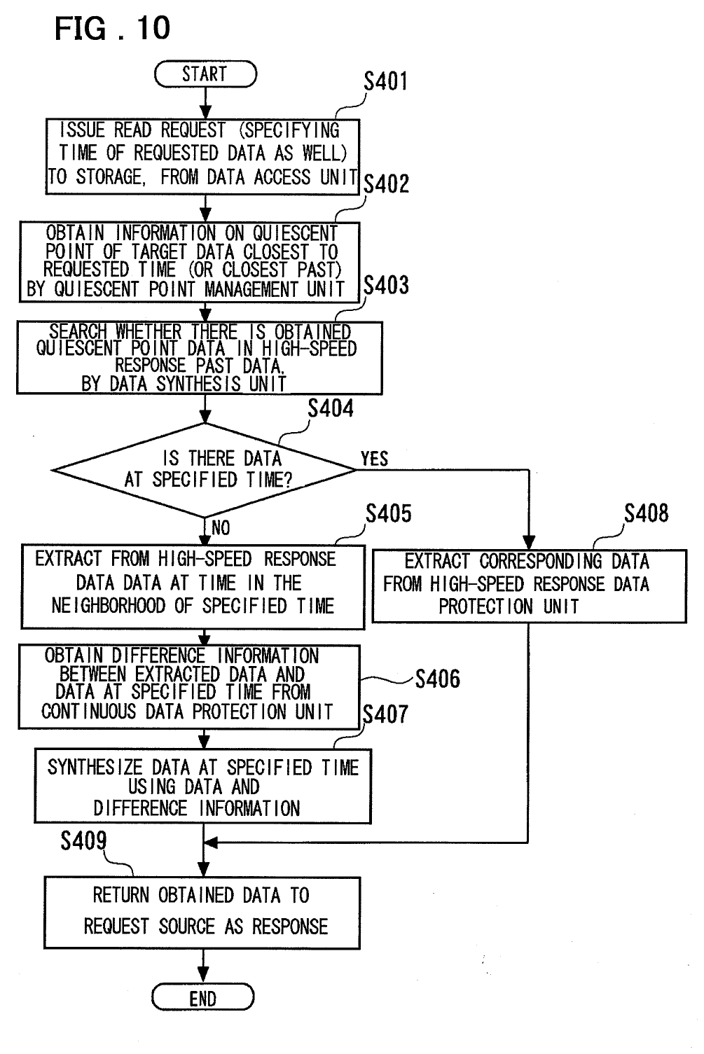

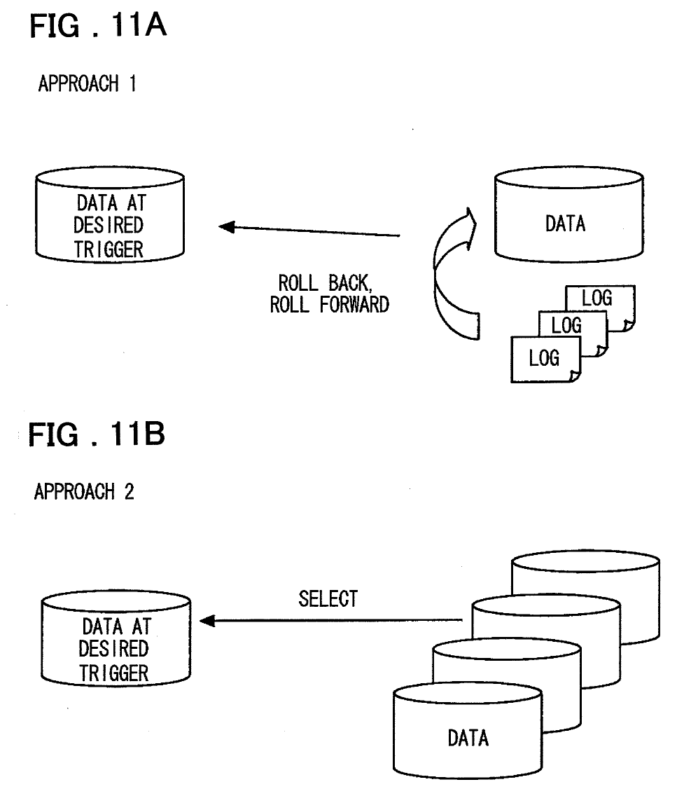

FIG. 10 is a flowchart explaining a READ operation in the second example of the present invention.

A READ request is issued to the storage 101 from the data access unit 105 (with a time of requested data also specified) (at step S401).

The quiescent point management unit 104 obtains information on a quiescent point closest to the requested time for the target data (which may be the closest past) (at step S402). The information on the quiescent point obtained by the quiescent point management unit 104 is notified to the data synthesis unit 113′ in the storage 101.

The data synthesis unit 113′ searches whether there is high-speed response past data at the quiescent point obtained by the quiescent point management unit 104 in the high-speed response past data protection unit 111 (at step S403).

When it is found that the data at the specified time is present in the high-speed response past data protection unit 111 (branch to YES at step S404), the data synthesis unit 113′ extracts the corresponding data from the high-speed response past data protection unit 111.

When it is found that the data at the specified time is not present in the high-speed response past data protection unit 111 (branch to NO at step S404), the data synthesis unit 113′ extracts from the high-speed response past data protection unit 111 neighboring data at a time in the neighborhood of the specified time (at step S405).

The data synthesis unit 113′ obtains from the continuous data protection unit 112 difference information between the extracted neighboring data and the data at the specified time (at step S406).

The data synthesis unit 113′ synthesizes the data at the specified time from the data at the time in the neighborhood of the specified time and the difference information (at step S407).

The data synthesis unit 113′ passes the data obtained at step S407 or S408 to the data access unit 105. The data access unit 105 returns the data to a request source, as the access result 109 for the access request (READ request) 108 (at step S409).

When past data is created using the present invention or a CDP technique, the created past data without alteration may be mixed in a current namespace, and discrimination between the past data and current data may sometimes not be made.

When access is made to the past data in a file B under a certain directory A, for example, the file B in the past appears under the directory A. When this past file B has the same file name as a current file B, contention between the names of the file B occurs under the directory A. Thus, the user cannot determine which one of the current file and the past file he is referencing.

Then, in order to solve this problem, the file name of the past data is changed, in this example. In the case of the example described above, when the file name of the file B is “file B.doc”, the file name of the past file B is changed so that the file name is regular and unique like “file B_{—}20050201.doc”.

In this case, the file name is changed to the one in which “_a date” (date) is automatically inserted between a designation and an extension. That is, “/A/file B.doc” is changed to “/A/file B_{—}20050201.doc”.

As another solving unit, a directory for holding past data may be prepared separately, and the past data may be arranged under the directory.

When an operation is performed under a rule that data at a certain date in the past is arranged under a directory “/.snapshot/yyyy/mm/dd/”, the file B in the example described above is presented to the user as “/.snapshot/2005/02/01/A/file B.doc”.

Assume that past data can be accessed using the present invention and the CDP technique. Then, an operation of the application may malfunction when the past data cannot be accessed by a namespace that is the same as that at a certain time point in the past. In the case of the application where access is made to a plurality of files, for example, a plurality of past data must be able to be accessed in the same manner as points in time in the past.

Then, in order to solve this problem, a directory that reproduces a point of time in the past is created on a storage side in this example. A client side mounts the directory and utilizes the mounted directory. When data at a point in time of “Feb. 1, 2005”, which is the time point in the past, is to be accessed, the storage reproduces the data at the time point without alteration in a directory structure at the point of time in the past under a directory “/.snapshot/2005/02/01”.

Then, the client side mounts this directory “/.snapshot/2005/02/01/” using an appropriate designation and uses this directory.

Then, the client side can access the directory structure at the point of time in the past of “Feb. 1, 2005” in the same manner as the time point in the past.

The above description was given to the first and second examples described before. Naturally, the present invention may be configured as a system that combines the trigger transmission unit 103 and the past data updating unit 102 in the first example with the quiescent point management unit 104 in the second example.

The above description was directed to the present invention in connection with the examples described above. The present invention is not limited to the configurations of the examples described above, and of course includes various variations and modifications that could be made by those skilled in the art within the scope of the present invention.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A storage system comprising:
a storage that stores data and that records update content of data in time series as a log when update of the data occurs and restores data at a point in time in the past to implement data protection function; and
a past data updating unit that creates data corresponding to a predetermined trigger using data and log information stored and held in said storage and stores the created data in said storage as the data corresponding to the predetermined trigger.

2. The storage system according to claim 1, further comprising:
a trigger transmission unit that extracts a predetermined trigger for data access based on at least a result of analysis of information on a history of access to said storage and information notified from outside;
wherein said past data updating unit creates data corresponding to the extracted predetermined trigger using data and log information stored and held in said storage and stores the created data in said storage as the data corresponding to the predetermined trigger.

3. The storage system according to claim 1, comprising:
a data synthesis unit that performs control so that the data created in advance and corresponding to the predetermined trigger is used as a response to an access request to said storage without performing data restoration when the access request to said storage is an access request to the data corresponding to the predetermined trigger, and
restores the data from the data and the log information stored and held in said storage and returns the restored data as a response to the access request when the data corresponding to the predetermined trigger is not stored in said storage.

4. The storage system according to claim 1, wherein the predetermined trigger includes a time point at which frequent access to said storage is performed or expected, the time point being derived from the information on the history of access to said storage.

5. The storage system according to claim 1, wherein the predetermined trigger is notified to the storage system from outside the storage system.

6. The storage system according to claim 1, wherein in said storage, past data at respective points in time mutually spaced with a predetermined time interval interposed therebetween is stored and held, being associated with the respective points in time;
regarding data update occurring in a time segment for which no past data is stored, update content is recorded in time series in the log as the difference information; and
the storage system includes:
a data synthesis unit that searches whether data at a point in time specified by an access request to said storage is stored in said storage as one of the past data and returns the past data at the specified time point as a response to the access request when the past data at the specified time point is present, and that obtains a neighboring one of the past data at a point in time in the neighborhood of the specified time point when the past data at the time point specified by the access request is not stored in said storage, obtains the log information corresponding to a difference between the neighboring past data and the data at the specified time point, restores the data corresponding to the specified time point from the neighboring past data and the log information, and then returns the restored data as a response to the access request.

7. A storage system comprising:
a storage that stores data and that records update content of data in time series as a log when update of the data occurs and is capable of restoring data at a point in time in the past to implement data protection function;
a quiescent point management unit that detects a quiescent point of data; and
a data synthesis unit that performs control so as to send back the data corresponding to the quiescent point as a response to an access request to said storage.

8. The storage system according to claim 1, wherein said storage comprises:
a response past data hold unit that holds past data for response;
a continuous data protection unit that performs continuous data protection; and
a data synthesis unit that synthesizes data using the data in said response past data hold unit and data in said continuous data protection unit; wherein
said past data updating unit, which is for creating data corresponding to a predetermined trigger in advance, restores the data corresponding to the predetermined trigger in advance with reference to the response past data in said response past data hold unit and the data in said continuous data protection unit, and stores the restored data in said response past data hold unit, corresponding to the predetermined trigger; and wherein
said data synthesis unit returns the data corresponding to the predetermined trigger, stored and held in said response past data hold unit, as a response to an access request to the data at the predetermined trigger, and
returns the data synthesized using the data in said response past data hold unit and the data in said continuous data protection unit as a response to an access request to data other than the data at the predetermined trigger.

9. The storage system according to claim 8, further comprising:
a trigger transmission unit that transmits the trigger to said past data updating unit based on a result of analysis of information on a history of access to said storage or information notified from outside.

10. The storage system according to claim 8, wherein said continuous data protection unit monitors data write access to said storage, and when a data update occurs, said continuous data protection unit journals a difference resulting from the data update to said storage as a log.

11. The storage system according to claim 9, wherein said trigger transmission unit notifies to said past data updating unit a time at which one of the past data should be held;
said past data updating unit extracts from the response past data held in said response past data hold unit a neighboring one of the response past data at a time in the neighborhood of the time notified from said trigger transmission unit, and obtains difference information between the neighboring data at the time in the neighborhood of the notified time and the data at the notified time; and
the data corresponding to the notified time is synthesized using the neighboring data and the difference information, and the synthesized data is stored in said response past data hold unit.

12. The storage system according to claim 9, wherein said trigger transmission unit notifies to said past data updating unit data unnecessary as one of the past data, and said past data updating unit deletes the notified past data from the response past data in said response past data hold unit.

13. The storage system according to claim 9, wherein said trigger transmission unit analyzes the information on the history of access to said storage, notifies to said past data updating unit a time with access concentrated thereat and access target data, and notifies to said past data updating unit deletion of one of the past data unused in said response past data hold unit.

14. The storage system according to claim 11, wherein when said past data updating unit stores the synthesized data in said response past data hold unit, said past data updating unit deletes the past data stored in said response past data hold unit.

15. The storage system according to claim 8, wherein upon receipt of a read request specifying a time, said data synthesis unit searches whether one of the response past data at the specified time is present in said responding data protection unit;
when the data at the specified time is present, said data synthesis unit extracts from said responding data protection unit the responding data at the specified time; and
when the data at the specified time is not present, said data synthesis unit extracts a neighboring one of the response past data at a time in the neighborhood of the specified time from said responding data protection unit, obtains difference information between the extracted neighboring data and the data at the specified time from said continuous data protection unit, and synthesizes the data at the specified time from the neighboring data and the difference information.

16. The storage system according to claim 7, wherein said storage comprises:
a response past data hold unit that holds past data for response;
a continuous data protection unit that performs continuous data protection; and
a data synthesis unit that synthesizes data from the data in said response past data hold unit and data in said continuous data protection unit; wherein
said quiescent point management unit, which is for detecting a quiescent point of an application and managing the quiescent point,
upon receipt of a request specifying a time to read required data from said storage, obtains information on the quiescent point closest to the requested time for the target data, and notifies the information on the quiescent point to said data synthesis unit in said storage; and wherein
said data synthesis unit searches whether one of the response past data at a time corresponding to the quiescent point obtained by said quiescent point management unit is present in said response past data hold unit, and extracts the data at the time corresponding to the quiescent point from said response past data hold unit when the data at the time corresponding to the quiescent point is present; and
said data synthesis unit extracts from said response past data hold unit a neighboring one of the response past data at a time in the neighborhood of the time corresponding to the quiescent point when the data at the time corresponding to the quiescent point is not present, obtains difference information between the extracted neighboring data and the data at the specified time, synthesizes the data at the specified time using the neighboring data and the difference information, and returning the synthesized data as a response.

17. A data protection method for a storage system comprising a storage including data protection function capable of restoring data at a point in time in the past by recording update content of the data in time series as a log when update of the data occurs, the method comprising:
creating data corresponding to a predetermined trigger using data and log information stored and held in said storage; and
storing the created data in said storage as the data corresponding to the predetermined trigger.

18. The method according to claim 17, comprising:
extracting a predetermined trigger for data access based on at least a result of analysis of information on a history of access to said storage and information notified from outside; and
creating data corresponding to the extracted predetermined trigger using data and log information stored and held in said storage;
and storing the created data in said storage as the data corresponding to the predetermined trigger.

19. The method according to claim 17, comprising:
performing control so that the data created in advance and corresponding to the predetermined trigger is used as a response to an access request to said storage without performing data restoration when the access request to said storage is an access request to the data corresponding to the predetermined trigger, and
restoring the data from the data and the log information stored and held in said storage and returning the restored data as a response to the access request when the data corresponding to the predetermined trigger is not stored in said storage.

20. The method according to claim 17, wherein the predetermined trigger includes a time point at which frequent access to said storage is performed or expected, the time point being derived from the information on the history of access to said storage.

21. The method according to claim 17, wherein the predetermined trigger is notified to the storage system from outside the storage system.

22. The method according to claim 17, wherein in said storage, past data at respective points in time mutually spaced with a predetermined time interval interposed therebetween is stored and held, being associated with the respective points in time;
regarding data update occurring in a time segment for which no past data is stored, update content is recorded in time series in the log as the difference information;
it is searched whether data at a point in time specified by the access request is stored in said storage as one of the past data and the past data at the specified time point is returned as a response to the access request when the past data at the specified time point is present; and
a neighboring one of the past data at a point in time in the neighborhood of the specified time point is obtained when the past data at the time point specified by the access request is not present, the log information corresponding to a difference between the neighboring past data and the data at the specified time point is obtained, the data corresponding to the specified time point is restored from the neighboring past data and the log information, and then the restored data is returned as a response to the access request.

23. A data protection method for a storage system comprising a storage including a data protection function capable of restoring data at a point in time in the past by recording update content of the data in time series as a log when update of the data occurs, the method comprising:
detecting a quiescent point of the data; and
performing control so that the data corresponding to the quiescent point is returned as a response to an access request to said storage.

24. A program for a computer constituting a storage system including a storage, said storage system including a data protection function capable of restoring data at a point in time in the past by executing processing of recording update content of the data in time series as a log when update of the data occurs, the program causing said computer to execute processing of:
creating data corresponding to a predetermined trigger using data and log information stored and held in said storage; and
storing the created data in said storage as the data corresponding to the predetermined trigger.

25. The program according to claim 24, causing said computer to execute processing of:
extracting a predetermined trigger for data access based on at least a result of analysis of information on a history of access to said storage and information notified from outside; and
creating data corresponding to the extracted predetermined trigger using data and log information stored and held in said storage and storing the created data in said storage as the data corresponding to the predetermined trigger.

26. The program according to claim 24, causing said computer to execute processing of:
performing control so that the data created in advance and corresponding to the predetermined trigger is used as a response to an access request to said storage without performing data restoration when the access request to said storage is an access request to the data corresponding to the predetermined trigger, and
restoring the data from the data and the log information stored and held in said storage and returning the restored data as a response to the access request when the data corresponding to the predetermined trigger is not stored in said storage.

27. The program according to claim 24, wherein said storage system comprises:
a response past data hold unit that holds past data for response; and
a continuous data protection unit that performs continuous data protection; wherein
said storage system executes:
past data updating processing of creating data corresponding to a predetermined trigger in advance; and
data synthesis processing of synthesizing data using the data in said response past data hold unit and data in said continuous data protection unit;
said program causing said computer to execute:
said past data updating processing of restoring the data corresponding to the predetermined trigger in advance with reference to the past data in said response past data hold unit and the data in said continuous data protection unit, and storing the restored data in said response past data hold unit; and
said data synthesis processing of returning one of the data stored and held in said response past data hold unit as a response to an access request to the data at the predetermined trigger, and returning the data synthesized using the data in said response past data hold unit and the data in said continuous data protection unit as a response to an access request to data other than the data at the predetermined trigger.

28. A program for a computer constituting a storage system including a storage, said storage system including a data protection function capable of restoring data at a point in time in the past by executing processing of recording update content of the data in time series as a log when update of the data occurs, the program causing said computer to execute processing of:
detecting a quiescent point of the data; and
performing control so that the data corresponding to the quiescent point is returned as a response to an access request to said storage.

29. The program according to claim 28, wherein said storage system comprises:
a response past data hold unit for holding response past data; and
a continuous data protection unit for performing continuous data protection; and wherein
said storage system executing:
data synthesis processing of synthesizing data using the data in said response past data hold unit and data in said continuous data protection unit; and
quiescent point management processing of detecting a quiescent point of an application and managing the quiescent point;
said program causing said computer to execute:
said quiescent point management processing of obtaining information on the quiescent point closest to a requested time for target data, and notifying the information on the quiescent point to said data synthesis processing in said storage, upon receipt of a read request specifying the time to read the required data from said storage processing; and
said data synthesis processing of searching whether one of the response past data at a time corresponding to the quiescent point obtained by said quiescent point management unit is present in said response past data hold unit, extracting from said response past data hold unit the data at the time corresponding to the quiescent point when the data at the time corresponding to the quiescent point is present, and extracting from said response past data hold unit a neighboring one of the response past data at a time in the neighborhood of the specified time corresponding to the quiescent point when the data at the specified time corresponding to the quiescent point is not present, obtaining difference information between the extracted neighboring data and the data at the specified time, synthesizing the data at the specified time using the neighboring data and the difference information, and returning the synthesized data as a response.
